(19) United States
(12) Patent Application Publication
(10) Pub. No.: US 2025/0150294 A1
(43) Pub. Date: May 8, 2025

(54) MANAGING NETWORK FUNCTIONS ASSOCIATED WITH USER EQUIPMENT TASK OFFLOADING

(71) Applicant: Nokia Technologies Oy, Espoo (FI)

(72) Inventors: Rakshesh PRAVINCHANDRA BHATT, Bangalore (IN); Ranganathan MAVUREDDI DHANASEKARAN, Munich (DE); Ranjana Kumari NAVALDE, Bangalore (IN); Divya G NAIR, Bangalore (IN); Joao Antonio PEREIRA RODRIGUES, Amadora (PT)

(21) Appl. No.: 18/935,244

(22) Filed: Nov. 1, 2024

(30) Foreign Application Priority Data
Nov. 2, 2023 (IN) 202311074952

(51) Int. Cl. H04L 12/14; H04L 41/16

(52) U.S. Cl. CPC H04L 12/1407; H04L 12/145; H04L 41/16

(57) ABSTRACT

Techniques are disclosed for managing one or more network functions associated with user equipment data exchange functionalities. While not necessarily limited thereto, disclosed techniques are well suited for implementation for managing charging functions associated with work task offloading for user equipment engaging in split artificial intelligence/machine learning (AIML) model processing in a communication network environment.

### FIELD

The field relates generally to communication networks, and more particularly, but not exclusively, to network function management in such communication networks.

### BACKGROUND

This section introduces aspects that may be helpful in facilitating a better understanding of the inventions. Accordingly, the statements of this section are to be read in this light and are not to be understood as admissions about what is in the prior art or what is not in the prior art.

While fourth generation (4G) wireless mobile telecommunications technology, also known as Long Term Evolution (LTE) technology, was designed to provide high-capacity mobile multimedia with high data rates particularly for human interaction, fifth generation (5G) technology is intended to be used not only for human interaction, but also for machine type communications in so-called Internet of Things (IOT) networks.

More particularly, 5G networks are intended to enable massive IoT services (e.g., very large numbers of limited capacity devices) and mission-critical IoT services (e.g., requiring high reliability), while also providing improvements over legacy mobile communication services in the form of enhanced mobile broadband (eMBB) services with improved wireless Internet access for mobile devices.

In an example communication system, user equipment (5G UE in a 5G network or, more broadly, a UE) such as a mobile terminal (subscriber) communicates over an air interface with a base station or access point of an access network referred to as a 5G AN in a 5G network. The access point (e.g., gNB) is illustratively part of an access network of the communication system.

For example, in a 5G network, the access network referred to as a 5G AN is described in 5G Technical Specification (TS) 23.501, entitled “Technical Specification Group Services and System Aspects; System Architecture for the 5G System,” and TS 23.502, entitled “Technical Specification Group Services and System Aspects; Procedures for the 5G System (5GS),” the disclosures of which are incorporated by reference herein in their entireties. In general, the access point (e.g., gNB) provides access for the UE to a core network (CN or 5GC), which then provides access for the UE to other UEs and/or a data network such as a packet data network (e.g., Internet). TS 23.501 goes on to define a 5G Service-Based Architecture (SBA) which models services as network functions (NFs) that communicate with each other using representational state transfer application programming interfaces (Restful APIs). Furthermore, TS 33.501, entitled “Technical Specification Group Services and System Aspects; Security Architecture and Procedures for the 5G System,” the disclosure of which is incorporated by reference herein in its entirety, further describes security management details associated with a 5G network.

In some cases, however, UEs can communicate with one another via a secure direct connection. One such exemplary case is known as work task offloading, i.e., where one UE offloads a work task to another UE by secure direct connection between UEs. In such cases, management of attributes associated with such a use case by one or more network functions of the core network (e.g., CN or 5GC) is an important consideration. However, due to continuing attempts to improve the architectures and protocols associated with a 5G network in order to increase network efficiency and/or subscriber convenience, network function management issues associated with such use cases can present a significant challenge.

### SUMMARY

Illustrative embodiments provide techniques for managing one or more network functions associated with user equipment data exchange functionalities. While not necessarily limited thereto, illustrative embodiments are well suited for implementation for managing charging functions associated with work task offloading for user equipment engaging in split artificial intelligence/machine learning (AIML) model processing in a communication network environment.

In one illustrative embodiment, from a network entity perspective, a method comprises receiving a message from an application requesting a service via a communication network. The method further comprises assisting in managing one or more charging policies for the service when performed by first user equipment and second user equipment, wherein the first user equipment and the second user equipment are in a data exchange relationship with respect to the service.

In another illustrative embodiment, from a consumer user equipment perspective, a method comprises receiving, at first user equipment, a message from an application requesting a service via a network entity of a communication network. The method further comprises establishing, by the first user equipment, a data exchange relationship with second user equipment proximate to the first user equipment to share performance of the service. The method further comprises sending, by the first user equipment, a message to the network entity comprising computation usage data for providing the service, and further indicating a role in the data exchange relationship that the first user equipment performed, to enable the communication network to implement one or more charging policies for the service with respect to the second user equipment.

In yet another illustrative embodiment, from a provider user equipment perspective, a method comprises receiving, at first user equipment, a message from second user equipment proximate to the first user equipment requesting a connection for use in establishing a data exchange relationship with the first user equipment to share performance of a service requested via a network entity of a communication network. The method further comprises sending, by the first user equipment, a message to the network entity comprising computation usage data for providing the service, and further indicating a role in the data exchange relationship that the first user equipment performed, to enable the communication network to implement one or more charging policies for the service with respect to the first user equipment.

Further illustrative embodiments are provided in the form of a non-transitory computer readable medium having embodied therein executable program code that when executed by a processor causes the processor to perform the above and/or other steps, operations, and the like. Still further illustrative embodiments comprise an apparatus with a processor and a memory configured to perform the above and/or other steps, operations, and the like. Some illustrative embodiments comprise a system configured to perform the above and/or other steps, operations, and the like. Further, some illustrative embodiments comprise an apparatus or a system comprising means for performing the above and/or other steps, operations, and the like.

Advantageously, illustrative embodiments provide techniques for managing charging functionalities in a communication network in a data exchange context (e.g., a work task offloading context between at least two UEs) with respect to performance of a service such as, but not limited to, a split AIML model processing service.

These and other features and advantages of embodiments described herein will become more apparent from the accompanying drawings and the following detailed description.

### BRIEF DESCRIPTION OF THE DRAWINGS

FIG. 1 illustrates a communication network environment with which one or more illustrative embodiments may be implemented.

FIG. 2 illustrates user equipment and entities with which one or more illustrative embodiments may be implemented.

FIGS. 3A through 3C illustrate a difference between scenarios involving work task offloading and no work task offloading with respect to user equipment operating in a split AIML model context within which one or more illustrative embodiments can be implemented.

FIG. 4 illustrates a converged charging system environment with which one or more illustrative embodiments can be implemented.

FIG. 5 illustrates a procedure for managing charging functions in a communication network environment with work task offloading functionality according to an illustrative embodiment.

FIGS. 6A through 6C illustrate exemplary message structures and trigger conditions associated with managing charging functions in a communication network environment with work task offloading functionality according to an illustrative embodiment.

### DETAILED DESCRIPTION

Embodiments will be illustrated herein in conjunction with example communication systems and associated techniques for network function management in communication systems. It should be understood, however, that the scope of the claims is not limited to particular types of communication systems and/or processes disclosed. Embodiments can be implemented in a wide variety of other types of communication systems, using alternative processes and operations. For example, although illustrated in the context of wireless cellular systems utilizing the 3rd Generation Partnership Project (3GPP) system elements such as a 3GPP next generation system (5G), the disclosed embodiments can be adapted in a straightforward manner to a variety of other types of communication systems such as 6G communication systems.

In accordance with illustrative embodiments implemented in a 5G communication system environment, one or more 3GPP technical specifications (TS) and technical reports (TR) may provide further explanation of network elements/functions and/or operations that may interact with parts of the inventive solutions, e.g., the above-referenced 3GPP TS 23.501, TS 23.502, and TS 33.501. Other 3GPP TS/TR documents may provide other details that one of ordinary skill in the art will realize, for example, TR 22.876: “Technical Specification Group Services and System Aspects; Study on AI/ML Model Transfer Phase 2,” TR 22.874: “Technical Specification Group Services and System Aspects; Study on Traffic Characteristics and Performance Requirements for AI/ML Model Transfer in 5GS,” TS 22.115: “Technical Specification Group Services and System Aspects; Service Aspects; Charging and Billing,” TS 32.277: “Technical Specification Group Services and System Aspects; Telecommunication Management; Charging Management; Proximity-based Services (ProSe) Charging,” TS 32.255: “Technical Specification Group Services and System Aspects; Telecommunication Management; Charging Management; 5G Data Connectivity Domain Charging; Stage 2,” and TS 32.290: “Technical Specification Group Services and System Aspects; Telecommunication Management; Charging Management; 5G system; Services, Operations and Procedures of Charging Using Service Based Interface (SBI),” the disclosure of which is incorporated by reference herein in its entirety. Note that 3GPP TS/TR documents are non-limiting examples of communication network standards (e.g., specifications, procedures, reports, requirements, recommendations, and the like). However, while well-suited for 5G-related 3GPP standards, embodiments are not necessarily intended to be limited to any particular standards.

It is to be understood that the term 5G network, and the like (e.g., 5G system, 5G communication system, 5G environment, 5G communication environment etc.), in some illustrative embodiments, may be understood to comprise all or part of an access network and all or part of a core network. However, the term 5G network, and the like, may also occasionally be used interchangeably herein with the term 5GC network, and the like, without any loss of generality, since one of ordinary skill in the art understands any distinctions.

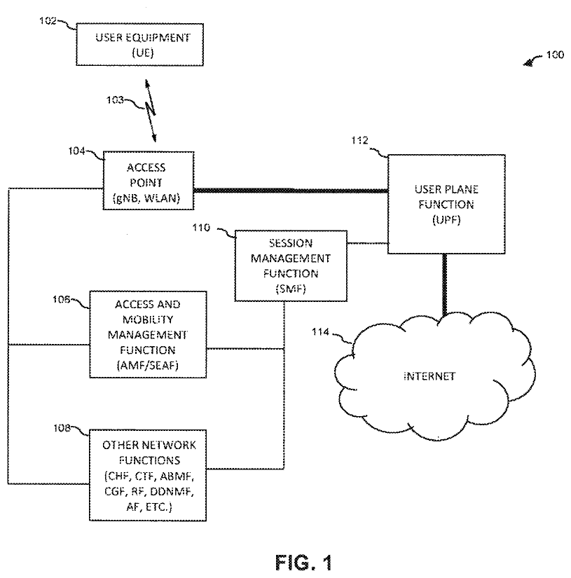

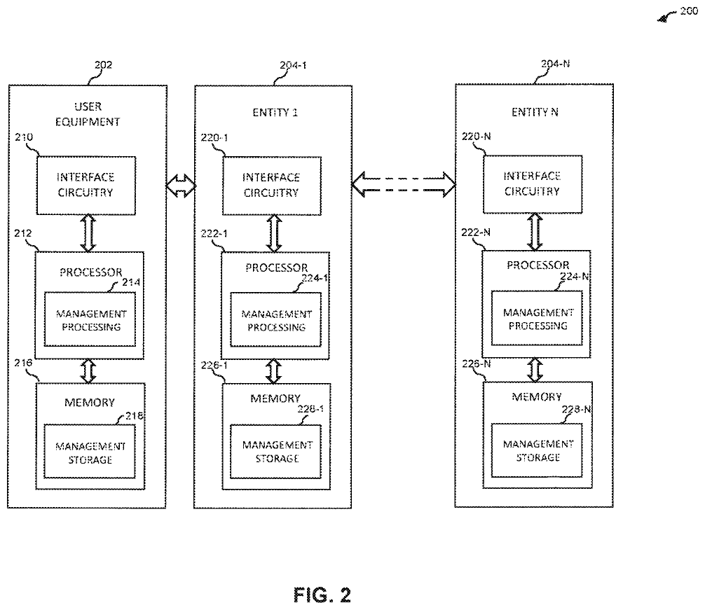

Prior to describing illustrative embodiments, a general description of certain main components of a 5G network will be described below in the context of FIGS. 1 and 2.

FIG. 1 shows a communication system 100 within which illustrative embodiments are implemented. It is to be understood that the elements shown in communication system 100 are intended to represent some main functions provided within the system, e.g., control plane functions, user plane functions, etc. As such, the blocks shown in FIG. 1 reference specific elements in 5G networks that provide some of these main functions. However, other network elements may be used to implement some or all of the main functions represented. Also, it is to be understood that not all functions of a 5G network are depicted in FIG. 1. Rather, at least some functions that facilitate an explanation of illustrative embodiments are represented. Subsequent figures may depict some additional elements/functions (i.e., network entities).

Accordingly, as shown, communication system 100 comprises user equipment (UE) 102 that communicates via an air interface 103 with an access point 104. It is to be understood that UE 102 may use one or more other types of access points (e.g., access functions, networks, etc.) to communicate with the 5GC network other than a gNB. By way of example only, the access point 104 may be any 5G access network (gNB), an untrusted non-3GPP access network that uses an Non-3GPP Interworking Function (N3IWF), a trusted non-3GPP network that uses a Trusted Non-3GPP Gateway Function (TNGF) or wireline access that uses a Wireline Access Gateway Function (W-AGF) or may correspond to a legacy access point (e.g., eNB). Furthermore, access point 104 may be a wireless local area network (WLAN) access point as will be further explained in illustrative embodiments described herein.

The UE 102 may be a mobile station, and such a mobile station may comprise, by way of example, a mobile telephone, a computer, an IoT device, or any other type of communication device. The term “user equipment” as used herein is therefore intended to be construed broadly, so as to encompass a variety of different types of mobile stations, subscriber stations or, more generally, communication devices, including examples such as a combination of a data card inserted in a laptop or other equipment such as a smart phone. Such communication devices are also intended to encompass devices commonly referred to as access terminals.

In one illustrative embodiment, UE 102 is comprised of a Universal Integrated Circuit Card (UICC) part and a Mobile Equipment (ME) part. The UICC is the user-dependent part of the UE and contains at least one Universal Subscriber Identity Module (USIM) and appropriate application software. The USIM securely stores a permanent subscription identifier and its related key, which are used to uniquely identify and authenticate subscribers to access networks. The ME is the user-independent part of the UE and contains terminal equipment (TE) functions and various mobile termination (MT) functions. Alternative illustrative embodiments may not use UICC-based authentication, e.g., a Non-Public (Private) Network (NPN).

Note that, in one example, the permanent subscription identifier is an International Mobile Subscriber Identity (IMSI) unique to the UE. In one embodiment, the IMSI is a fixed 15-digit length and consists of a 3-digit Mobile Country Code (MCC), a 3-digit Mobile Network Code (MNC), and a 9-digit Mobile Station Identification Number (MSIN). In a 5G communication system, an IMSI is referred to as a Subscription Permanent Identifier (SUPI). In the case of an IMSI as a SUPI, the MSIN provides the subscriber identity. Thus, only the MSIN portion of the IMSI typically needs to be encrypted. The MNC and MCC portions of the IMSI provide routing information, used by the serving network to route to the correct home network. When the MSIN of a SUPI is encrypted, it is referred to as Subscription Concealed Identifier (SUCI). Another example of a SUPI uses a Network Access Identifier (NAI). NAI is typically used for IOT communication.

The access point 104 is illustratively part of a radio access network or RAN of the communication system 100. Such a radio access network may comprise, for example, a 5G System having a plurality of base stations. Components of a radio access network may, more generally, be considered “radio access entities.”

Further, the access point 104 in this illustrative embodiment is operatively coupled to an Access and Mobility Management Function (AMF/SEAF) 106. In a 5G network, the AMF/SEAF supports, inter alia, mobility management (MM) and security anchor (SEAF) functions.

AMF/SEAF 106 in this illustrative embodiment is operatively coupled to (e.g., uses the services of) other network functions 108. As shown, some of these other network functions 108 include, but are not limited to, a Charging Function (CHF), a Charging Trigger Function (CTF), an Account and Balance Management Function (ABMF), a Charging Gateway Function (CGF), a Rating Function (RF), a Direct Discovery Name Management Function (DDNMF), and an Application Function (AF). These listed network function examples are typically implemented in the home network of the UE subscriber, further explained below. Some or all of the functions operate to enable a communication service provider (CSP) to perform convergent or converged charging which brings together online and offline charging systems to address new and emerging 5G monetization use cases. In general, the CHF collects network and service usage data and enables payments (understands how much a user should be charged for services consumed) and allows CSPs to create new services and offers and roll these out quickly and efficiently to consumers. The AF exposes the application layer for interaction with 5G NFs and network resources, e.g., split AIML functionalities, as will be further explained herein. DDNMF is the logical 5G NF that handles network related actions required for dynamic ProSe Direct Discovery. The DDNMF in the HPLMN may interact with the DDNMF in a VPLMN or local PLMN in order to manage the ProSe Direct Discovery service. ProSe Direct Discovery is a procedure employed by a ProSe-enabled UE to discover other ProSe-enabled UEs in its vicinity (proximity) based on direct radio transmissions (direct device connection or sidelink) between the two UEs with NR technology. Note that NFs may, more generally, be considered “network entities.”

Note that a UE, such as UE 102, is typically subscribed to what is referred to as a Home Public Land Mobile Network (HPLMN) in which some or all of the functions 106 and 108 reside. Alternatively the UE, such as UE 102, may receive services from an NPN where these functions may reside. The HPLMN is also referred to as the Home Environment (HE). If the UE is roaming (not in the HPLMN), it is typically connected with a Visited Public Land Mobile Network (VPLMN) also referred to as a visited network, while the network that is currently serving the UE is also referred to as a serving network. In the roaming case, some of the functions 106 and 108 can reside in the VPLMN, in which case, functions in the VPLMN communicate with functions in the HPLMN as needed. However, in a non-roaming scenario, access and mobility management functions 106 and the other network functions 108 reside in the same communication network, i.e., HPLMN. Embodiments described herein, unless otherwise specified, are not necessarily limited by which functions reside in which PLMN (i.e., HPLMN or VPLMN).

The access point 104 is also operatively coupled (via one or more of functions 106 and/or 108) to a Session Management Function (SMF) 110, which is operatively coupled to a User Plane Function (UPF) 112. UPF 112 is operatively coupled to a Packet Data Network, e.g., Internet 114. Note that the thicker solid lines in this figure denote a user plane (UP) of the communication network, as compared to the thinner solid lines that denote a control plane (CP) of the communication network. It is to be appreciated that network (e.g., Internet) 114 in FIG. 1 may additionally or alternatively represent other network infrastructures including, but not limited to, cloud computing infrastructure and/or edge computing infrastructure. Further typical operations and functions of such network elements are not described here since they are not the focus of the illustrative embodiments and may be found in appropriate 3GPP 5G documentation. Note that functions shown in 106, 108, 110 and 112 are examples of network functions (NFs).

It is to be appreciated that this particular arrangement of system elements is an example only, and other types and arrangements of additional or alternative elements can be used to implement a communication system in other embodiments. For example, in other embodiments, the communication system 100 may comprise other elements/functions not expressly shown herein.

Accordingly, the FIG. 1 arrangement is just one example configuration of a wireless cellular system, and numerous alternative configurations of system elements may be used. For example, although only single elements/functions are shown in the FIG. 1 embodiment, this is for simplicity and clarity of description only. A given alternative embodiment may of course include larger numbers of such system elements, as well as additional or alternative elements of a type commonly associated with conventional system implementations.

It is also to be noted that while FIG. 1 illustrates system elements as singular functional blocks, the various subnetworks that make up the 5G network are partitioned into so-called network slices. Network slices (network partitions) are logical networks that provide specific network capabilities and network characteristics that can support a corresponding service type, optionally using network function virtualization (NFV) on a common physical infrastructure. With NFV, network slices are instantiated as needed for a given service, e.g., eMBB service, massive IoT service, and mission-critical IoT service. A network slice or function is thus instantiated when an instance of that network slice or function is created. In some embodiments, this involves installing or otherwise running the network slice or function on one or more host devices of the underlying physical infrastructure. UE 102 is configured to access one or more of these services via access point 104.

FIG. 2 is a block diagram illustrating computing architectures for various participants in methodologies according to illustrative embodiments. More particularly, system 200 is shown comprising user equipment (UE) 202 and a plurality of entities 204-1, . . . , 204-N. For example, in illustrative embodiments and with reference back to FIG. 1, UE 202 can represent UE 102 (as well as any UE functioning as a consumer and/or a provider in a work task offloading context as will be further described herein), while entities 204-1, . . . , 204-N can represent functions 106 and 108 (i.e., network entities such as, but not limited to, CHF, CTF, ABMF, CGF, RF, DDNMF, AF), as well as access point 104 (i.e., radio access entity such as, but not limited to, a RAN node or gNB). It is to be appreciated that the UE 202 and entities 204-1, . . . , 204-N are configured to interact to provide management (e.g., charging functions associated with work task offloading in a split AIML model processing context) and other techniques described herein.

The user equipment 202 comprises a processor 212 coupled to a memory 216 and interface circuitry 210. The processor 212 of the user equipment 202 includes a management processing module 214 that may be implemented at least in part in the form of software executed by the processor. The management processing module 214 performs management described in conjunction with subsequent figures and otherwise herein. The memory 216 of the user equipment 202 includes a management storage module 218 that stores data generated or otherwise used during management operations.

Each of the entities (individually or collectively referred to herein as 204) comprises a processor 222 (222-1, . . . , 222-N) coupled to a memory 226 (226-1, . . . , 226-N) and interface circuitry 220 (220-1,, 220-N). Each processor 222 of each entity 204 includes a management processing module 224 (224-1, . . . , 224-N) that may be implemented at least in part in the form of software executed by the processor 222. The management processing module 224 performs management operations described in conjunction with subsequent figures and otherwise herein. Each memory 226 of each entity 204 includes a management storage module 228 (228-1,, 228-N) that stores data generated or otherwise used during management operations.

The processors 212 and 222 may comprise, for example, microprocessors such as central processing units (CPUs), application-specific integrated circuits (ASICs), digital signal processors (DSPs) or other types of processing devices, as well as portions or combinations of such elements.

The memories 216 and 226 may be used to store one or more software programs that are executed by the respective processors 212 and 222 to implement at least a portion of the functionality described herein. For example, management operations and other functionality as described in conjunction with subsequent figures and otherwise herein may be implemented in a straightforward manner using software code executed by processors 212 and 222.

A given one of the memories 216 and 226 may therefore be viewed as an example of what is more generally referred to herein as a computer program product or still more generally as a computer or processor readable (non-transitory or storage) medium that has executable program code embodied therein. Other examples of computer or processor readable media may include disks or other types of magnetic or optical media, in any combination. Illustrative embodiments can include articles of manufacture comprising such computer program products or other computer or processor readable media.

Further, the memories 216 and 226 may more particularly comprise, for example, electronic random-access memory (RAM) such as static RAM (SRAM), dynamic RAM (DRAM) or other types of volatile or non-volatile electronic memory. The latter may include, for example, non-volatile memories such as flash memory, magnetic RAM (MRAM), phase-change RAM (PC-RAM) or ferroelectric RAM (FRAM). The term “memory” as used herein is intended to be broadly construed, and may additionally or alternatively encompass, for example, a read-only memory (ROM), a disk-based memory, or other type of storage device, as well as portions or combinations of such devices.

The interface circuitries 210 and 220 illustratively comprise transceivers or other communication hardware or firmware that allows the associated system elements to communicate with one another in the manner described herein.

It is apparent from FIG. 2 that user equipment 202 and plurality of entities 204 are configured for communication with each other as management participants via their respective interface circuitries 210 and 220. This communication involves each participant sending data to and/or receiving data from one or more of the other participants. The term “data” as used herein is intended to be construed broadly, so as to encompass any type of information that may be sent between participants including, but not limited to, identity data, key pairs, key indicators, tokens, secrets, management messages, registration request/response messages and data, request/response messages, authentication request/response messages and data, metadata, control data, audio, video, multimedia, consent data, other messages, etc.

It is to be appreciated that the particular arrangement of components shown in FIG. 2 is an example only, and numerous alternative configurations may be used in other embodiments. For example, any given network element/function and/or access point can be configured to incorporate additional or alternative components and to support other communication protocols.

Other system elements such as access point 104, SMF 110, and UPF 112 may each be configured to include components such as a processor, memory and network interface. Also, entities such as third-party applications and network operators can participate in methodologies described herein via computing devices configured to include components such as a processor, memory and network interface. These elements and devices need not be implemented on separate stand-alone processing platforms, but could instead, for example, represent different functional portions of a single common processing platform.

More generally, FIG. 2 can be considered to represent processing devices configured to provide respective management functionalities and operatively coupled to one another in a communication system. By way of example only, all or parts of each of UE 202 and the plurality of entities 204 (e.g., processor and memory) can be considered examples of means for performing one or more operations, one or more steps, one or more functions, one or more processes, etc. as described herein.

As mentioned above, the 3GPP TS 23.501 defines the 5GC network architecture as service-based, e.g., Service-Based Architecture (SBA). It is realized herein that in deploying different NFs, there can be many situations where an NF may need to interact with an entity external to the SBA-based 5GC network (e.g., including the corresponding PLMN(s), e.g., HPLMN and VPLMN). Thus, the term “internal” as used herein illustratively refers to operations and/or communications within the SBA-based 5GC network (e.g., SBA-based interfaces) and the term “external” illustratively refers to operations and/or communications outside the SBA-based 5GC network (non-SBA interfaces).

Given the above general description of some features of a 5GC network, problems with existing approaches in managing one or more network functions associated with user equipment work task offloading functionalities in a communication network environment, and solutions proposed in accordance with illustrative embodiments, will now be described herein below. While not limited thereto, illustrative embodiments will be described in the context of managing charging functions associated with work task offloading for user equipment engaging in split artificial intelligence/machine learning (AIML) model processing in a communication network environment. Further, it is to be appreciated that term work task offloading relationship is one example of a data exchange relationship with respect to the requested service (e.g., split AIML model processing). Still further, while some illustrative embodiments are described with respect to a work task offloading relationship between two UEs, it is to be understood that more than two UEs can be involved in the same work task offloading relationship for the requested service according to further illustrative embodiments.

Work task offloading or, more particularly, proximity-based work task offloading, is based on a third party's request for one UE, i.e., a relay UE, to receive data from another UE, i.e., a remote UE, via a secure direct (device-to-device) connection and perform calculation of a work task for the remote UE. The calculation result can be further sent to a network server or NF.

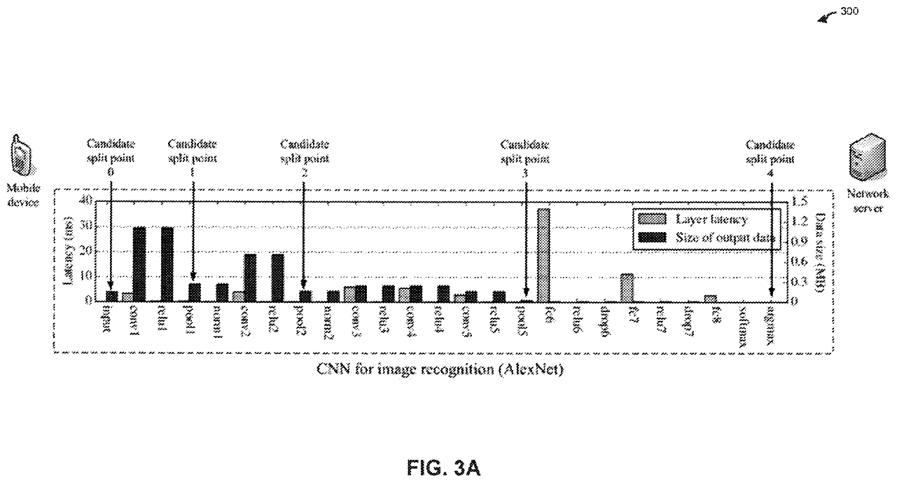

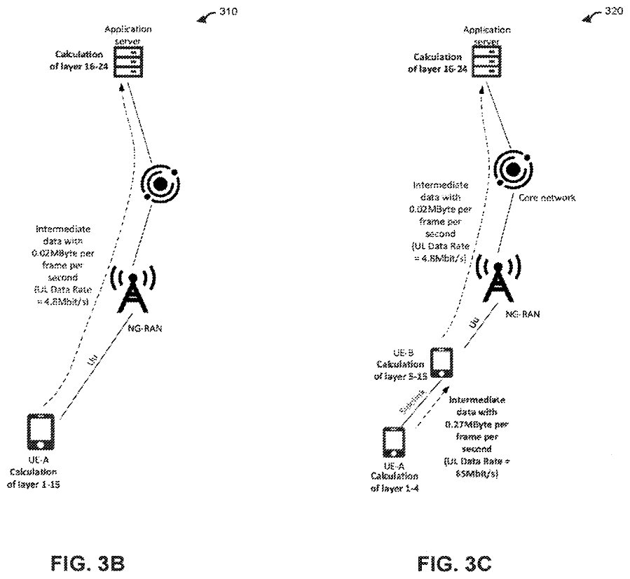

In the context of one particular use case, proximity-based work task offloading can be utilized for AIML inference model processing. Model splitting, wherein different devices or functions (e.g., one or more UEs and one or more network functions or servers) compute different layers of the AIML inference model, is an important feature for AI inference model processing. In some scenarios, it is realized herein that the number of devices or functions computing layers, and the amount of data transmission, correspond to different model splitting points. For example, FIG. 3A shows a layer-level computation/communication resource evaluation 300 for an example AIML model, e.g., an AlexNet model. A general trend is realized wherein the more layers a UE calculates, the less intermediate data needs to be transmitted to the network server (e.g., application). Further, when a UE has low computation capacity (e.g., due to a low battery), the application can change the splitting point to enable the UE to calculate fewer layers while increasing the data rate in the Universal Mobile Telecommunications System (UMTS) air interface, referred to as the Uu interface, for transmitting a higher load of intermediate data to the network server.

However, sometimes the data rate cannot be increased due to radio resource (e.g., gNB) limitations. In such circumstances, the UE with low computation capacity needs to offload the computation task to a proximate UE (e.g., a relay UE) while still maintaining the computation service and letting the proximate UE send the calculated data to the network server. Thus, by offloading the work task using a secure direct device connection, the original UE's computation load will be released while the data rate in the Uu interface will not necessarily be increased either, which leads to better network performance.

More particularly, FIG. 3B shows a service flow 310 where no work task offloading occurs while FIG. 3C shows a service flow 320 where work task offloading occurs.

As shown in service flow 310 in FIG. 3B, UE-A is performing image recognition using a convolutional neural network (CNN) of the AlexNet model represented in FIG. 3A. Assume that UE-A selects splitting point-3 for the AI inference. It is realized that the end-to-end (E2E) service latency (including image recognition latency and intermediate data transmission latency) is one second. However, when the UE-A's battery becomes low, it cannot afford the heavy work task for the AlexNet model (i.e., calculating layers 1-15 for AlexNet model on the local (UE) side).

Thus, as shown in service flow 320 in FIG. 3C, further assume that, while managed by the 5G network (CN or 5GC), UE-A discovers UE-B (e.g., another mobile subscriber terminal or a customer premise equipment (CPE)) which has installed the same model and is willing to take the offloading task from UE-A. Note that the 5G network does not store UE-A and UE-B's location data.

As further shown in FIG. 3C, UE-A establishes a sidelink (i.e., a secure direct device connection) to UE-B. During the sidelink establishment, assume that UE-B also obtains the information of the total service latency (including the image recognition latency and intermediate data transmission latency) and the processing time consumed by UE-A for computing layers 1-4.

Since UE-B has acquired the E2E service latency and the processing time consumed by UE-A, and also knows its own processing time for computing layers 5-15, UE-B can determine the quality-of-service (QOS) parameters applied to both the Uu interface and the sidelink while keeping the same (i.e., one second) E2E service latency.

Note that it is assumed that UE-A and UE-B have the same computation capacity, i.e., the time used for computing the particular AlexNet model layers are the same for UE-A and UE-B. Otherwise, the data rate on the Uu interface and the sidelink may be changed accordingly.

As further shown in FIG. 3C, UE-A sends the intermediate data (i.e., data after calculating layers 1-4) to UE-B via the sidelink, and UE-B performs the further processing and transmits the intermediate data (i.e., data after calculating layers 5-15) to the network (application) server via the Uu interface. The specific model layers being computed by UE-A and UE-B are shown in FIG. 3C. UE-A continues to perform image recognition by leveraging the sidelink and UE-B's computation capacity while the source and destination Internet Protocol (IP) address and the E2E service latency for the image recognition service is unchanged.

Thus, as depicted in FIG. 3C, a direct device connection (e.g., sidelink) can advantageously be used to realize the proximity-based work task offloading. In this case, the data rate for UE-A on the Uu interface need not be increased while UE-A's computation load is offloaded to UE-B.

However, it is realized herein that such proximity-based work task offloading with respect to split AIML model processing, as illustratively described above in the context of FIGS. 3A through 3C, or the like, can cause significant challenges to a converged charging system, utilized by the CN or 5GC, to collect charging information.

For example, the above-referenced 3GPP TS 22.115 considers requirements where the 5GC is able to collect and provide charging information in terms of duration and amount of data transmitted/received, QoS, etc. Such requirements hold good for conventional call-processing related charging. However, it is realized herein that for the split AIML model processing use case, or the like, where computation resources of a proximity UE are used, users of the proximity UE providing such resources should be benefited according to the amount of computation resources shared. For such a requirement, it is realized herein that the 5GC needs to collect AIML computation specific information and use that for determining charging policies.

It is also realized herein that the 5GC needs to allow an operator or an authorized third party to configure the charging policies for proximity-based work task offloading for AIML. These charging policies should be defined in a manner that motivates the users of UEs to provide user consent for sharing their computation resources. These policies will be different from the conventional charging where the operators charge UEs for providing services.

It is still further realized herein that, in some scenarios, a third party may be able to provide UEs with high computation capabilities specifically for providing proximity-based work task offloading services for AIML. By way of example only, airport authorities or local governments (more generally, entities) may decide to install devices at the airport which not only provide additional AIML computation capabilities to UEs at the airport, but also share airport security related information within the devices as well as to a network (application) server. In such scenarios, since the additional computation capabilities are provided by the devices installed by airport authorities, the charging policies should also be defined by them. It is to be appreciated that such devices installed at locations as explained here may be referred to as customer premise equipment (CPE). Such CPE, whether stationary and/or mobile, can be more generally referred to as one or more UEs.

Illustrative embodiments enable the above and other features and advantages, and thus overcome the above and other technical drawbacks of existing approaches, by providing improved techniques for managing charging functionalities in the context of work task offloading with respect to split AIML model processing or the like.

As used herein with respect to one or more illustrative embodiments, the term “AIML service provider” is used for the UE which provides the AIML work offload service to another UE in proximity, while the term “AIML service consumer” is used for the UE which requests the AIML work offload service from the AIML service provider.

As will be further illustrated and explained, illustrative embodiments provide techniques that allow a network operator (e.g., CSP) to define charging policies for proximity-based work task offloading for AIML. In some illustrative embodiments, the policies defined enable AIML service provider UEs to get credits for the computation work offloaded if the owners of the UEs have provided user-consent. In some illustrative embodiments, the policies are defined based on one or more of the number of layers of computation provided, the number of times such computation services are used by AIML service consumer UEs in proximity, the number of times desired performance key performance indicators (KPIs) are met, and the priority of the requests served.

If AIML service provider UEs are owned by a third party, for example, airport authorities or local governments deciding to install such AIML assistant UEs (e.g., CPE) at airports or such public places, an offline charging agreement can be agreed upon between the network operator and the third party. The charging policies may be defined according to such agreements in such scenarios. For such scenarios, charging policies may include bulk credits based on the number of such UEs installed and the number of times the desired performance KPIs are met.

In some illustrative embodiments, the policies can be implemented to monitor the performance KPIs before providing the credits for the AIML service provider UEs. In one non-limiting example scenario, if UEs that have sufficient AIML computation capabilities provide user consent but are not able to meet the expected performance KPIs, such UEs do not get the credits for providing the computation services, and their user consent is revoked.

In some illustrative embodiments, charging information is collected from the AIML service provider UE in order to give credits for the computation service provided by that UE. One or more charging functions can collect this information in addition to the information collected from the AIML service consumer UE, as will be further explained in detail below.

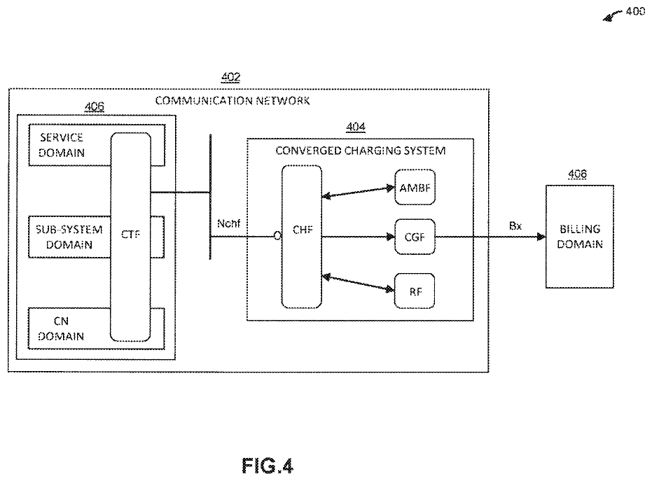

FIG. 4 illustrates an exemplary converged charging system environment 400 with which one or more illustrative embodiments can be implemented. Converged or convergent charging brings together online and offline charging systems to address both types of charging scenarios that a network operator engages in with its users. As generally shown in converged charging system environment 400, a communication network 402 comprises a converged charging system 404 operatively coupled to a set of domains 406. Converged charging system 404 comprises a Charging Function (CHF) operatively coupled to an Account and Balance Management Function (ABMF), a Charging Gateway Function (CGF), and a Rating Function (RF), while the set of domains 406 comprises a service domain, a sub-system domain and a core network (CN) domain each having a Charging Trigger Function (CTF). CGF is operatively coupled to a billing domain 408. Further details of the operation of the various functions in converged charging system environment 400 can be found in the above-referenced 3GPP TS 32.277. However, as explained above, converged charging system environment 400, when implemented with existing charging management functionalities, does not address the work task offloading scenario, particularly in the context of split AIML model processing.

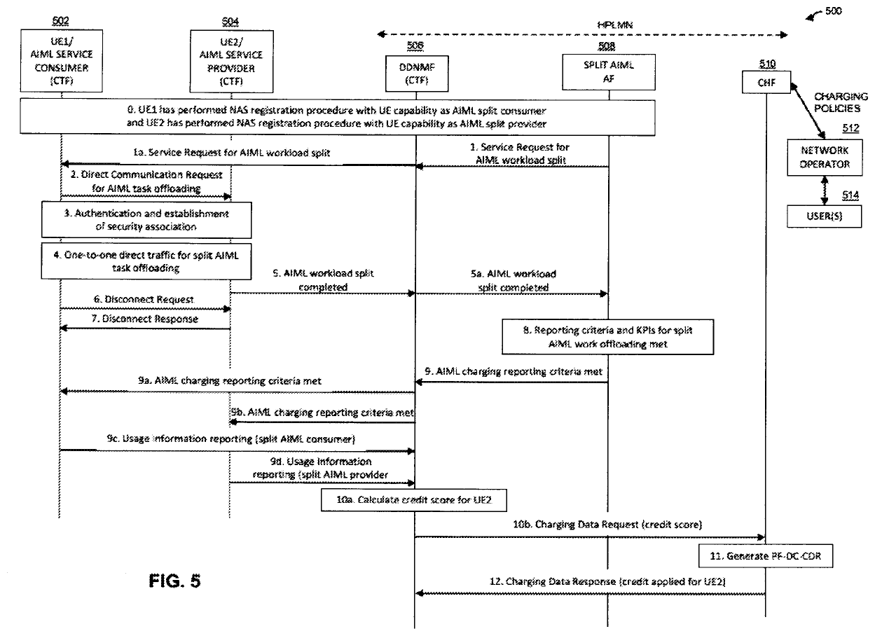

Referring now to FIG. 5, a procedure 500 for managing charging functions in a communication network environment with work task offloading functionality is depicted according to an illustrative embodiment. More particularly, procedure 500 manages converged charging functionalities for a work task offloading scenario in the context of split AIML model processing. Thus, procedure 500 can be implemented in accordance with converged charging system environment 400 of FIG. 4 or any other charging system in a communication network context as may be suitable.

As shown, procedure 500 involves a UE 502 (e.g., a CTF of UE1 functioning as an AIML service consumer), UE 504 (e.g., a CTF of UE2 functioning as an AIML service provider), a DDNMF 506 (e.g., a CTF of DDNMF), a split AIML AF 508, and a CHF 510. In this example, DDNMF 506, split AIML AF 508 and CHF 510 are part of the HPLMN of UEs 502 and 504. In cases where UE 502 and/or UE 504 are roaming, the DDNMF in the corresponding VPLMN (not expressly shown) can communicate with DDNMF 506 of the HPLMN as needed.

Also shown in procedure 500 is a network operator 512 operatively coupled to CHF 510 and user(s) 514. As illustratively explained above, recall that network operator 512 (e.g., CSP) can agree on charging policies (i.e., including credit policies) with user(s) 514 of UEs (e.g., UE 504) that provide work task offloading functionality for other UEs (e.g., UE 502). These policies can include, but are not limited to, charging policies for proximity-based work task offloading for AIML where AIML service provider UEs to get credits for the computation work offloaded if the owners of the UEs have provided user consent. In some illustrative embodiments, the policies are defined based on one or more of the number of layers of computation provided, the number of times such computation services are used by AIML service consumer UEs in proximity, the number of times desired performance key performance indicators (KPIs) are met, and the priority of the requests served. If AIML service provider UEs are owned by a third party, for example, airport authorities or local governments deciding to install such AIML assistant UEs (e.g., CPE) at airports or such public places, an offline charging agreement can be agreed upon between the network operator and the third party. The charging policies may be defined according to such agreements in such scenarios. For such scenarios, charging policies may include bulk credits based on the number of such UEs installed and the number of times the desired performance KPIs are met. In some illustrative embodiments, the policies can be implemented to monitor the performance KPIs before providing the credits for the AIML service provider UEs. In one non-limiting example scenario, if UEs that have sufficient AIML computation capabilities provide user consent but are not able to meet the expected performance KPIs, such UEs do not get the credits for providing the computation services, and their user consent is revoked.

It is to be appreciated that such policies can be set by network operator 512 in a converged charging system comprising CHF 510 prior to steps 0 through 12 being performed, or otherwise updated during steps 0 through 12 as may be desired/required.

Step 0: As part of non-access stratum (NAS) registration, it is assumed that UE 502(UE1) registered as an AIML service consumer and UE 504 (UE2) registered as an AIML service provider. The AIML service for which UEs 502 and 504 are registered is a split AIML model processing service managed by split AIML AF 508.

Steps 1, 1a: A service request for an AIML workload split is shared from split AIML AF 508 to DDNMF 506 and then to UE 502 which is registered as the AIML service consumer.

Step 2: As a result, after a discovery procedure triggered from UE 502, UE 502 establishes a direct communication with UE 504 which is registered as the AIML service provider.

Step 3: Authentication and security procedures are completed between UE 502 and UE 504.

Step 4: For the requested split task, one-to-one direct traffic is established between UE 502 and UE 504 (via a secure direct device connection, e.g., sidelink) and UE 504 performs the required task assigned (e.g., recall the above split AIML model processing example where the consumer UE with a low battery condition computed layers 1-4 of an AIML model and the provider UE computed layers 5-15 of the AIML model on behalf of the consumer UE).

Steps 5, 5a: Once the split task is completed, UE 504 shares this results in an AIML work split complete message to split AIML AF 508 through DDNMF 506.

Steps 6, 7: The direct device connection between UE 502 and UE 504 is disconnected. Step 8: Split AIML AF 508 checks if the reporting criteria (service-based criteria) are met for the assigned task based on the input received in step 5a.

Steps 9, 9a, 9b: The status about the reporting criteria are shared to UE 502 and UE 504 through DDNMF 506.

Steps 9c, 9d: Usage reporting information is shared with DDNMF 506 from UE 502 and UE 504 with an extra parameter indicating the role as split AIML service consumer and split AIML service provider, respectively.

Step 10a: DDNMF 506 computes the credit score for UE 504, which is the AIML service provider. In this step, the credit score (computation credit score) is a value representing the specific quantifiable computational effort UE 504 expended in performing the split AIML model processing (e.g., computing layers 5-15 of the AIML model). This is distinguishable from the term credit with regard to how much of a monetary credit the user (owner) of UE 504 will receive from the converged charging system for performing the computational effort.

Step 10b: A charging data request including the credit score is sent from DDNMF 506 CHF 510.

Step 11: CHF 510 generates a ProSe Function-Direct Communication-Charging Data Record (PF-DC-CDR) using inputs received.

Step 12: CHF 510 responds to DDNMF 506 with a charging data response including the credit score for UE 504.

Note that, in some illustrative embodiments, when establishing the work task offloading relationship with UE 504, UE 502 sends to UE 504 the E2E latency information (e.g., one second), the specific AIML model it supports for split operation (e.g., AlexNet model), and the layer supported limit (e.g., layers 1-4) for the operation.

In illustrative embodiments that implement techniques described in the above-referenced 3GPP TS 32.277, particularly for ProSe direct discovery, the ProSe Function (PF) collects the following charging information: the identity of the mobile subscriber using the ProSe functionality, e.g., IMSI; the identity of the PLMN where the ProSe functionality is used; the specific ProSe functionality used, e.g., Announcing, Monitoring, or Match Report, split AIML; and the role of the UE in the ProSe, e.g., Announcing UE, Monitoring UE, Discoveree UE, Discoverer UE, split AIML consumer/service provider.

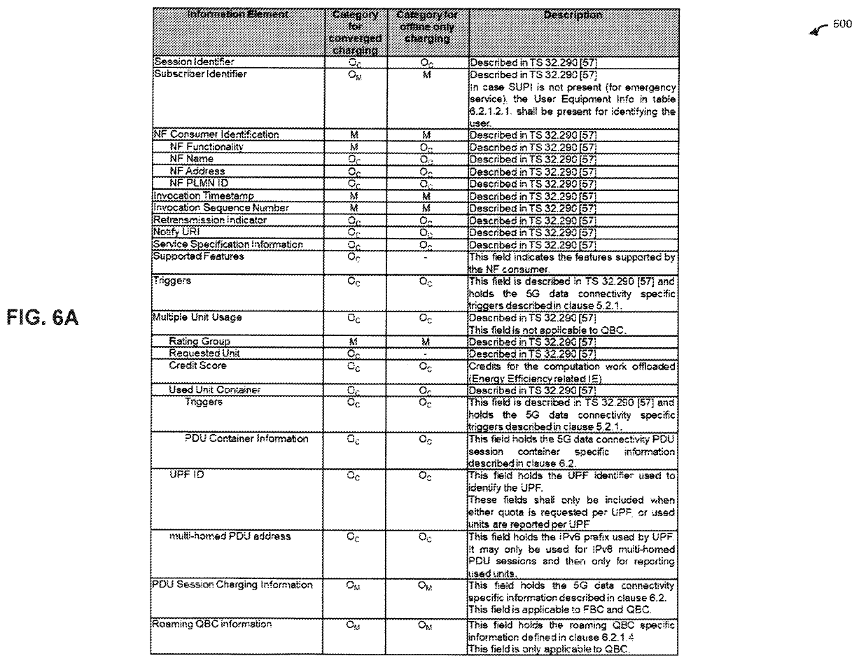

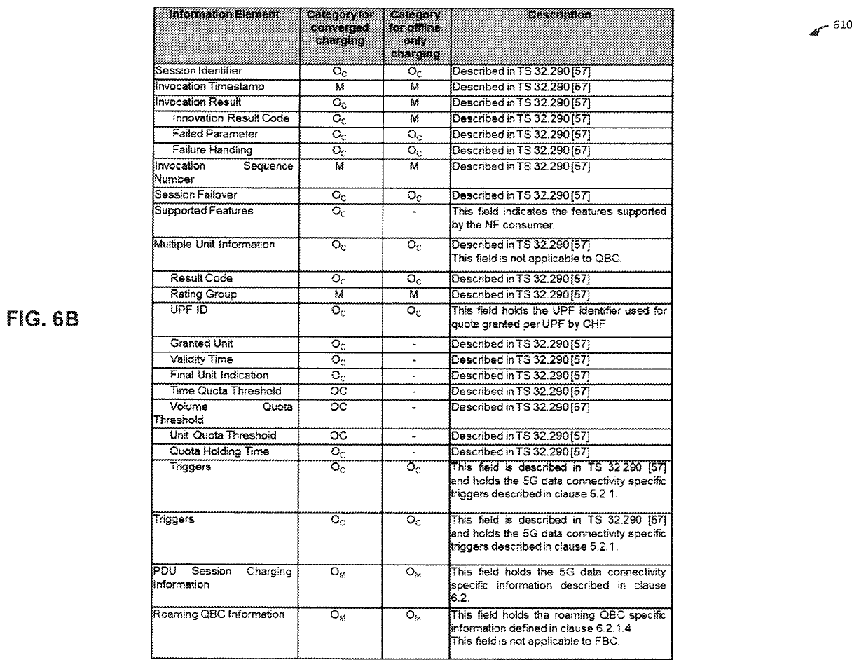

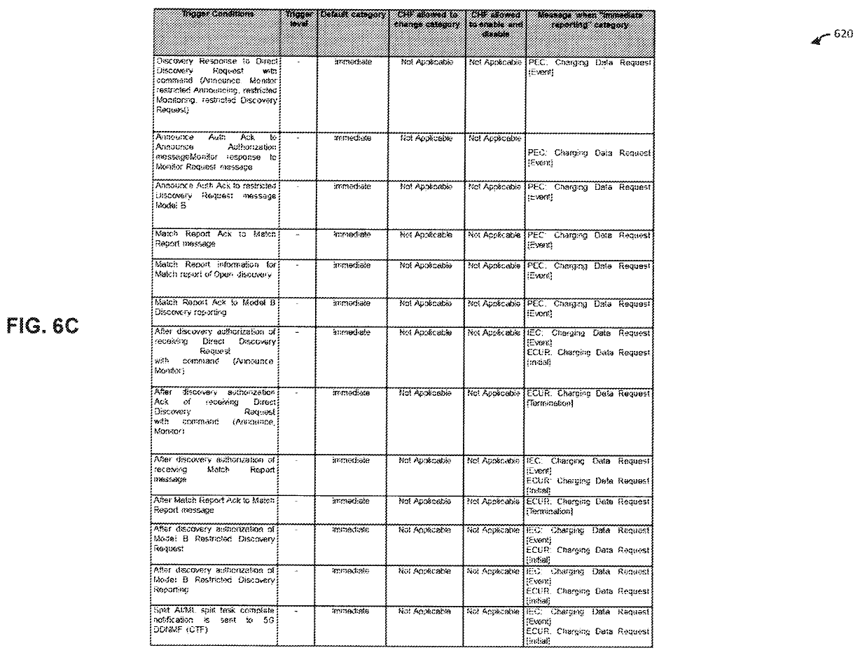

Furthermore, changes in the above-referenced 3GPP TS 32.255 for charging data message structures (i.e., to include a credit score as explained above in steps 10a through 12) are respectively depicted in FIGS. 6A for message content structure 600 and FIG. 6B for message content structure 610. FIG. 6C shows new trigger conditions in a table 620 adapted for the above-referenced 3GPP TS 32.277 for split AIML model processing in the context of a work task offloading scenario.

Accordingly, at least one illustrative embodiment may comprise an apparatus (e.g., corresponding to a network entity such as DDNMF 506) comprising at least one processor and at least one memory storing instructions that, when executed by the at least one processor, cause the apparatus at least to: receive a message from an application requesting a service via a communication network; and assist in managing one or more charging policies for the service when at least partially performed by first user equipment (e.g., corresponding to a consumer UE such as UE 502) and second user equipment (e.g., corresponding to a provider UE such as UE 504), wherein the first user equipment and the second user equipment are in a data exchange relationship with respect to the service.

In some further illustrative embodiments, assisting in managing the one or more charging policies may further comprise one or more of: sending the message requesting the service to the first user equipment; receiving a message from the second user equipment indicating completion of the service; sending the message indicating completion of the service to the application; receiving a message from the application indicating that service-based criteria have been met; sending the message indicating that the service-based criteria have been met to the first user equipment and the second user equipment; receiving respective messages from the first user equipment and the second user equipment comprising respective computation usage data for providing the service, wherein the respective messages further indicate a role in the data exchange relationship that the first user equipment and the second user equipment performed (wherein the respective messages from the first user equipment and the second user equipment may comprise respective computation usage data for providing the service indicate that the first user equipment performed a service consumer role and the second user equipment performed a service provider role); computing a computation credit score for the second user equipment; and sending the computed computation credit score for the second user equipment to a charging system to enable a charging result based on the one or more charging policies.

In some further illustrative embodiments, the data exchange relationship comprises a work task offloading relationship and the service comprises a split artificial intelligence-machine learning model processing service.

In some further illustrative embodiments, the one or more charging policies are settable by a network operator and comprise a policy to give an entity associated with the second user equipment charging credit for computational effort expended by the second user equipment in performing a quantifiable part of the service.

In some further illustrative embodiments, the one or more charging policies are settable by the network operator in conjunction with the entity associated with the second user equipment.

Still further, at least one illustrative embodiment may comprise an apparatus (e.g., corresponding to a consumer UE such as UE 502) comprising at least one processor and at least one memory storing instructions that, when executed by the at least one processor, cause the apparatus at least to: receive a message from an application requesting a service via a network entity of a communication network; establish a data exchange relationship with user equipment proximate to the apparatus to share performance of the service; and send a message to the network entity comprising computation usage data for providing the service, and further indicating a role in the data exchange relationship that the apparatus performed, to enable the communication network to implement one or more charging policies for the service with respect to the proximate user equipment.

In addition, at least one illustrative embodiment may comprise an apparatus (e.g., corresponding to a provider UE such as UE 504) comprising at least one processor and at least one memory storing instructions that, when executed by the at least one processor, cause the apparatus at least to: receive a message from user equipment proximate to the apparatus requesting a connection for use in establishing a data exchange relationship with the proximate user equipment to share performance of a service requested via a network entity of a communication network; and send a message to the network entity comprising computation usage data for providing the service, and further indicating a role in the data exchange relationship that the apparatus performed, to enable the communication network to implement one or more charging policies for the service with respect to the apparatus.

As used herein, it is to be understood that the term “communication network” in some embodiments can comprise two or more separate communication networks. Further, the particular processing operations and other system functionality described in conjunction with the diagrams described herein are presented by way of illustrative example only and should not be construed as limiting the scope of the disclosure in any way. Alternative embodiments can use other types of processing operations and messaging protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the various embodiments described herein are presented by way of illustrative example only and should not be construed as limiting the scope of the claims. For example, alternative embodiments can utilize different communication system configurations, user equipment configurations, base station configurations, provisioning and usage processes, messaging protocols and message formats than those described above in the context of the illustrative embodiments. These and numerous other alternative embodiments within the scope of the appended claims will be readily apparent to those skilled in the art.

1. A method comprising:
receiving a message from an application requesting a service via a communication network; and
assisting in managing one or more charging policies for the service when performed by first user equipment and second user equipment, wherein the first user equipment and the second user equipment are in a data exchange relationship with respect to the service;
wherein the steps are performed by at least one processor and at least one memory storing instructions executable by the at least one processor.

2. The method of claim 1, wherein the data exchange relationship comprises a work task offloading relationship and the service comprises a split artificial intelligence-machine learning model processing service.

3. The method of claim 1, wherein the one or more charging policies are settable by a network operator and comprise a policy to give an entity associated with the second user equipment charging credit for computational effort expended by the second user equipment in performing a quantifiable part of the service.

4. The method of claim 3, wherein the one or more charging policies are settable by the network operator in conjunction with the entity associated with the second user equipment.

5. The method of claim 1, wherein assisting in managing the one or more charging policies further comprises:
sending the message requesting the service to the first user equipment;
receiving a message from the second user equipment indicating completion of the service;
sending the message indicating completion of the service to the application;
receiving a message from the application indicating that service-based criteria have been met;
sending the message indicating that the service-based criteria have been met to the first user equipment and the second user equipment;
receiving respective messages from the first user equipment and the second user equipment comprising respective computation usage data for providing the service, wherein the respective messages further indicate a role in the data exchange relationship that the first user equipment and the second user equipment performed;
computing a computation credit score for the second user equipment; and
sending the computed computation credit score for the second user equipment to a charging system to enable a charging result based on the one or more charging policies.

6. An apparatus comprising:
at least one processor; and at least one memory storing instructions that, when executed by the at least one processor, cause the apparatus at least to perform:
receiving a message from an application requesting a service via a network entity of a communication network;
establishing a data exchange relationship with user equipment proximate to the apparatus to share performance of the service; and
sending a message to the network entity comprising computation usage data for providing the service, and further indicating a role in the data exchange relationship that the apparatus performed, to enable the communication network to implement one or more charging policies for the service with respect to the proximate user equipment.

7. The apparatus of claim 6, wherein the message indicates that the apparatus performed a service consumer role and the proximate user equipment performed a service provider role.

8. The apparatus of claim 6, wherein the data exchange relationship comprises a work task offloading relationship and the service comprises a split artificial intelligence-machine learning model processing service.

9. The apparatus of claim 6, wherein the one or more charging policies are settable by a network operator and comprise a policy to give an entity associated with the proximate user equipment charging credit for computational effort expended by the proximate user equipment in performing a quantifiable part of the service.

10. The apparatus of claim 9, wherein the one or more charging policies are settable by the network operator in conjunction with the entity associated with the proximate user equipment.

11. The apparatus of claim 6, wherein the network entity comprises a direct discovery name management function.

12. The apparatus of claim 6, wherein the apparatus comprises user equipment.

13. A method comprising:
receiving, at first user equipment, a message from an application requesting a service via a network entity of a communication network;
establishing, by the first user equipment, a data exchange relationship with second user equipment proximate to the first user equipment to share performance of the service; and
sending, by the first user equipment, a message to the network entity comprising computation usage data for providing the service, and further indicating a role in the data exchange relationship that the first user equipment performed, to enable the communication network to implement one or more charging policies for the service with respect to the second user equipment;
wherein the steps are performed by at least one processor and at least one memory storing instructions executable by the at least one processor.

14. An apparatus comprising:
at least one processor; and at least one memory storing instructions that, when executed by the at least one processor, cause the apparatus at least to perform:
receiving a message from user equipment proximate to the apparatus requesting a connection for use in establishing a data exchange relationship with the proximate user equipment to share performance of a service requested via a network entity of a communication network; and
sending a message to the network entity comprising computation usage data for providing the service, and further indicating a role in the data exchange relationship that the apparatus performed, to enable the communication network to implement one or more charging policies for the service with respect to the apparatus.

15. The apparatus of claim 14, wherein the message indicates that the apparatus performed a service provider role and the proximate user equipment performed a service consumer role.

16. The apparatus of claim 14, wherein the data exchange relationship comprises a work task offloading relationship and the service comprises a split artificial intelligence-machine learning model processing service.

17. The apparatus of claim 14, wherein the one or more charging policies are settable by a network operator and comprise a policy to give an entity associated with the apparatus charging credit for computational effort expended by the apparatus in performing a quantifiable part of the service.

18. The apparatus of claim 17, wherein the one or more charging policies are settable by the network operator in conjunction with the entity associated with the apparatus.

19. The apparatus of claim 14, wherein the network entity comprises a direct discovery name management function.

20. The apparatus of claim 14, wherein the apparatus comprises user equipment.
